(19) United States
(12) Patent Application Publication
(10) Pub. No.: US 2017/0282774 A1
(43) Pub. Date: Oct. 5, 2017

(54) VEHICLE ACCESSIBILITY SYSTEM

(71) Applicant: Proterra Inc., Greenville, SC (US)

(72) Inventor: Seneca SCHEPMANN, Greenville, SC (US)

(21) Appl. No.: 15/087,132

(22) Filed: Mar. 31, 2016

(51) Int. Cl. B60P 1/43

(52) U.S. Cl. CPC B60P 1/431; B60P 1/433

(57) ABSTRACT

A vehicle accessibility system may include an interior ramp panel movable between a first position and a second position; a first floor panel movable between a lowered position and a raised position; and a second floor panel movable between a horizontal position and a tilted position.

### TECHNICAL FIELD

This disclosure is directed to an accessibility system to help users ascend from a lower level to a higher level. More specifically, this disclosure is directed towards a vehicle accessibility system to help passengers aboard a vehicle.

### BACKGROUND

Buses and other transit vehicles often include a ramp for wheelchair passengers to use when boarding the vehicle. Existing wheelchair ramps may include two panels: a first panel that is secured to the bus floor and a second panel that folds out through the doors of the vehicle and to the ground to form a ramp. To achieve an adequate, usable slope, the ramp may extend far from the bus and may, for example, extend over most of the width of a nearby sidewalk. Furthermore, users in wide chairs may have difficulty using the ramp because the ramp has to be narrow enough to fit between the vehicle doors. Some vehicles may further include a system for lowering the height of the vehicle, to make it easier for passengers to step up into the bus. Lowering and raising the entire weight of a vehicle requires a large amount of energy and may lower the efficiency of a vehicle.

### SUMMARY

Embodiments of the present disclosure relate to, among other things, a vehicle accessibility system. Each of the embodiments disclosed herein may include one or more of the features described in connection with any of the other disclosed embodiments.

In one example, a vehicle accessibility system may include an interior ramp panel movable between a first position and a second position; a first floor panel movable between a lowered position and a raised position; and a second floor panel movable between a horizontal position and a tilted position.

Additionally or alternatively, the vehicle accessibility system may include one or more of the following features: the system may further comprise an exterior ramp panel movable between a first position and a second position; in the first position, the exterior ramp panel may be at least partially underneath the vehicle, and in the second position, the exterior ramp panel may be at least partially protruding from a side of the vehicle; the exterior and interior ramp panels may be configured to align to form a ramp from a ground surface into the vehicle; at least one of the interior ramp panel or the first floor panel may be movable to a level higher than a level of a fixed floor portion of the vehicle; in the raised position, the first floor panel may be parallel to and at a same level as a level of a fixed floor portion of the vehicle; and in the horizontal position, the second floor panel may be parallel to a fixed floor portion of the vehicle, and in the tilted position, the second floor panel may extend from a level of the fixed floor portion to a level of the first floor panel.

In another example, a vehicle accessibility system may include an exterior ramp panel protruding from the vehicle and contacting a ground surface; an interior ramp panel extending from the exterior ramp panel to a first floor panel of the vehicle, wherein the exterior and interior ramp panels are aligned to form a ramp from the ground surface into the vehicle; a first floor panel having a first edge contacting the interior ramp panel; and a second floor panel contacting a second edge of the first floor panel, wherein the second floor panel forms a ramp from the first floor panel to a fixed floor portion of the vehicle.

Additionally or alternatively, the vehicle accessibility system may include one or more of the following features: the exterior ramp panel may be slidable relative to and coupled to the interior ramp panel; the exterior ramp panel may be slidable relative to and coupled to a chassis of the vehicle; the interior ramp panel may be movable from the position aligned with the exterior ramp panel to form the ramp from the ground surface into the vehicle to a horizontal position parallel to the fixed floor portion of the vehicle; the first floor panel may be movable between a lowered position and a raised position; in the raised position, the first floor panel may be parallel to and at a same level as a level of the fixed floor portion of the vehicle; and the second floor panel may be movable between the position forming the ramp from the first floor panel to the fixed floor portion of the vehicle to a position parallel to the fixed floor portion of the vehicle.

In yet another example, a method for using a vehicle accessibility system may include: sliding an exterior ramp panel relative to an interior ramp panel; tilting an interior ramp panel from a horizontal position to a tilted position; and at least one of raising or lowering a first floor panel.

Additionally or alternatively, the method may include one or more of the following features or steps: the method may further comprise moving a second floor panel; the exterior ramp panel may be coupled to a chassis of the vehicle; the at least one of raising or lowering the first floor panel may include lowering the first floor panel to a level below a level of a fixed floor portion of the vehicle; the sliding may occur until an edge of the exterior ramp panel contacts a ground surface outside of the vehicle; and after the sliding and tilting, the exterior and interior ramp panels may be aligned to form a ramp from a ground surface into the vehicle.

It is understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 is a perspective view of a bus with a vehicle accessibility system in a first configuration, according to an exemplary embodiment.

FIG. 2 is a perspective view of a bus with a vehicle accessibility system in a second configuration, according to an exemplary embodiment.

FIG. 3 is a perspective view of a bus with a vehicle accessibility system in a third configuration, according to an exemplary embodiment.

FIG. 4 illustrates two different positions of a vehicle accessibility system with the exterior ramp panel deployed, according to exemplary embodiments.

FIG. 5 illustrates two different positions of a vehicle accessibility system with the exterior ramp panel retracted, according to exemplary embodiments.

### DETAILED DESCRIPTION

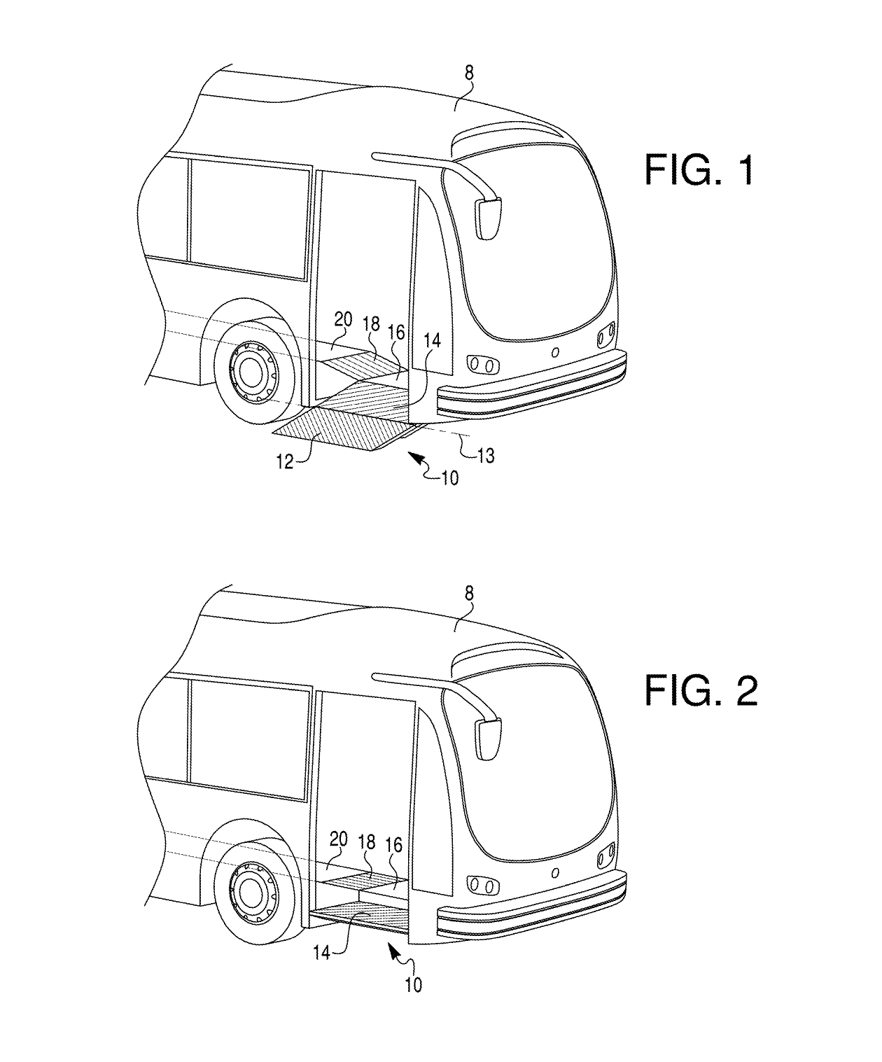

The present disclosure is drawn to an accessibility system. Although illustrated and described as a vehicle accessibility system, the disclosed system may be used in other settings to aid a user in ascending from a lower level to a higher level. The system may include a plurality of panels, which each may move relative to each other in various ways (e.g., up, down, tilt, slide) to increase the accessibility and efficiency of the vehicle. The figures illustrate a variety of different configurations of the system showing the panels in different positions. Referring to FIG. 1, the system 10 may include an exterior ramp panel 12, an interior ramp panel 14, a first floor panel 16, and a second floor panel 18.

In FIG. 1, the exterior ramp panel 12 is shown extending from a side of a vehicle 8. The exterior ramp panel 12 may align with the interior ramp panel 14 such that the two panels form a ramp from the ground into the vehicle 8. In one example, the exterior ramp panel 12 may rest on top of interior ramp panel 14 in a retracted (or storage) position and may fold out from the interior ramp panel 14 around axis 13 (e.g., like opening a book) to extend into an extended (or deployed) position. In this embodiment, the exterior and interior panels 12, 14 may be connected at their edges by one or more hinges. In an alternative example, the exterior ramp panel 12 may slide out from above or below the interior ramp panel 14. In this example, the exterior and interior panels 12, 14 may be slidable relative to each other and connected to each other, for example, by a track system. In yet another example, the exterior ramp panel 12 may be mounted underneath or above the chassis of a vehicle, for example, by a track system. If mounted underneath, for example, the exterior ramp panel 12 may slide outward from underneath the vehicle to deploy, and an edge closest to the vehicle may then be raised upwards to meet with an edge of the interior ramp panel 14.

Still referring to FIG. 1, the interior ramp panel 14 may be in a tilted position such that one edge contacts the first floor panel 16 and the other edge contacts the exterior ramp panel 12. The interior ramp panel 14 may be configured to raise, lower, or tilt. In FIG. 2, for example, the interior ramp panel 14 is shown in a horizontal position, such that a step is formed between the interior ramp panel 14 and the first floor panel 16. The interior ramp panel 14 may lower even further to decrease the distance between the ground and the interior ramp panel 14, or it may be raised to the level of the first floor panel 16.

The first floor panel 16 may be adjacent to the interior ramp panel 14 on an opposite side of the interior ramp panel 14 from the deployed exterior ramp panel 12. In one example, the first floor panel 16 may be raised and lowered. In FIG. 1, the first floor panel 16 is shown in a lowered position. The second floor panel 18 may be positioned adjacent to the first floor panel 16. In one embodiment, one edge of the first floor panel 16 contacts the interior ramp panel 14 and an adjacent edge of the first floor panel 16 contacts the second floor panel 18. As shown in FIG. 1, when the first floor panel 16 is in a lowered position, the second floor panel 18 may be tilted to connect the first floor panel 16 to the fixed flooring 20.

In FIG. 2, the first floor panel 16 is shown in a raised position at the same level as the fixed flooring 20, and the second floor panel 18 is shown in a horizontal position to connect the first floor panel 16 and the fixed flooring 20. When the first floor panel 16 is in a lowered position, a user may ascend a ramp formed by the second floor panel 18 to ascend from the first floor panel 16 to the fixed flooring 20. Alternatively, the first floor panel 16 may be moved from the lowered position to the raised position to bring the first floor panel 16 to the same level as the fixed flooring 20 and to bring the second floor panel 18 to a horizontal position.

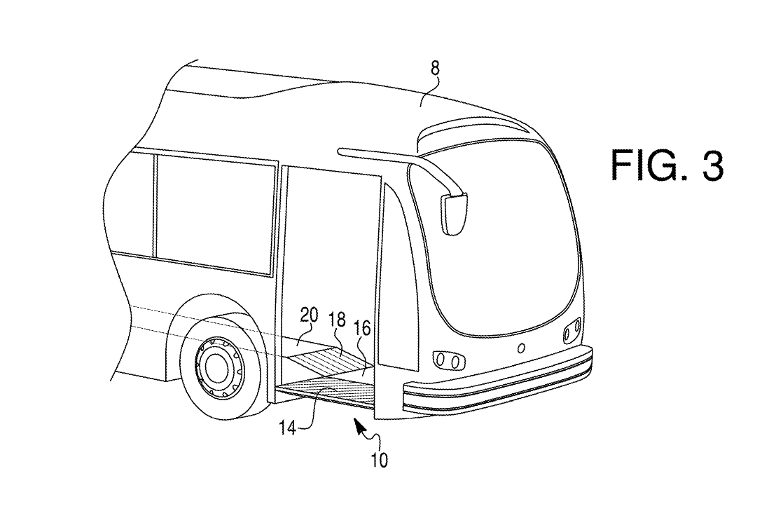

Referring to FIG. 3, the first floor panel 16 is shown in a lowered position, as in FIG. 1. Accordingly, the second floor panel 18 may form a ramp from the first floor panel 16 to the fixed flooring 20. However, in FIG. 3, the interior ramp panel 14 may be in a horizontal position, as in FIG. 2, and may be aligned with the first floor panel 16. If the exterior ramp panel 12 is not deployed, a user may step from the ground onto the interior ramp panel 14. Alternatively, the interior ramp panel 14 may be tilted to form a ramp from the ground to the first floor panel 16.

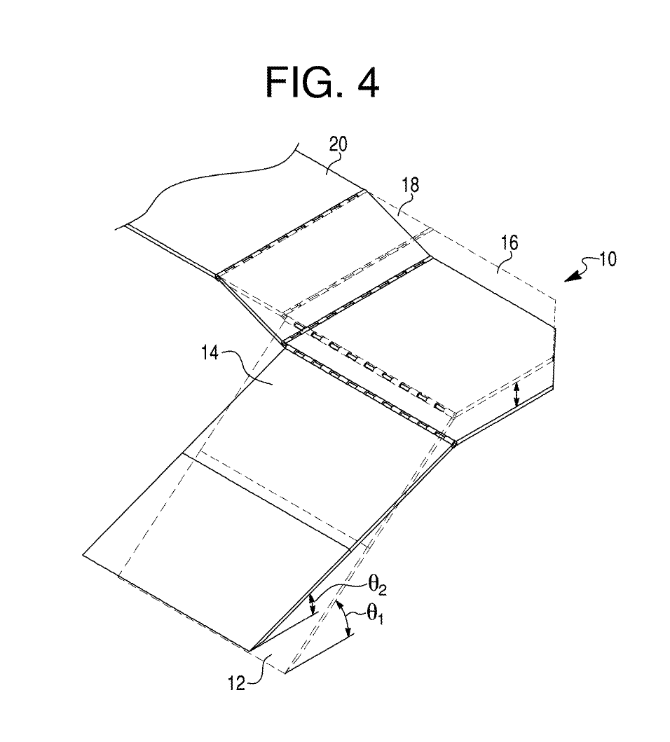

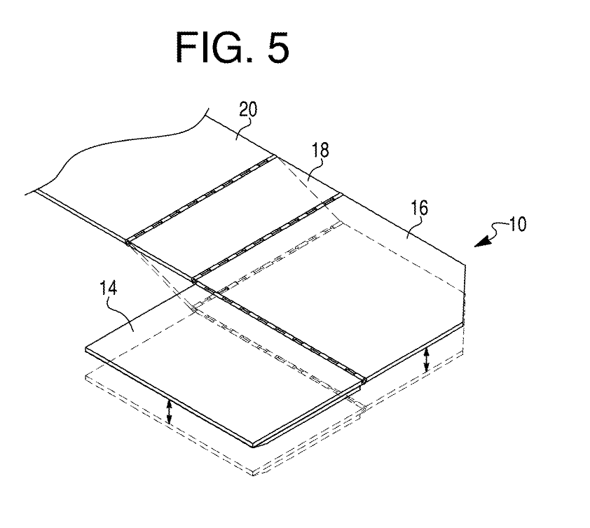

FIGS. 4 and 5 illustrate two additional configurations of the system 10. The system 10 is shown separate from a vehicle to illustrate various positions of the panels. Furthermore, although some adjacent panels are shown having a pivot connection around an axis, other connection mechanisms may be possible. For example, interior ramp panel 14 may be raised and lowered independently from first floor panel 16, in which case there would not be the pivot connection between the two panels as shown in FIGS. 4 and 5.

In FIG. 4, in the configuration shown in dotted lines, the first floor panel 16 and the second floor panel 18 may each be positioned at the same level (height) as the fixed flooring 20. The interior ramp panel 14 may be tilted so that its edge contacts an edge of the first floor panel 16, and the interior and exterior ramp panels 14, 12 may form a first ramp angle θ₁ with the ground. However, when the first floor panel 16 is lowered (shown in solid lines) and the second floor panel 18 is tilted to connect the first floor panel 16 to the fixed flooring 20, the interior and exterior ramp panels 14, 12 may form a second ramp angle θ₂ with the ground. θ₂ may be less than θ₁. Accordingly, the system 10 may allow the ramp angle to be adjusted to suit the needs of various passengers.

The ability to lower the height of the first flooring panel 16 and to tilt the interior ramp panel 14 may allow the exterior ramp panel 12 to have a shorter length than the exterior portion of pre-existing ramp systems. Pre-existing systems in which the floor of the vehicle is all the same level (e.g., portions of the vehicle floor that would be where panels 14, 16, and 18 are located in system 10) would require a longer exterior ramp panel than system 10 to achieve a desired ramp angle because the exterior ramp panel would have to extend from the ground to the full height of the vehicle floor (e.g., to the level of fixed flooring 20). In contrast, system 10 provides a first floor panel 16 that can be lowered, as well as an interior ramp panel 14 that can be lowered and/or tilted towards the ground, reducing the vertical distance that must be covered by the exterior ramp panel 12. Similarly, the exterior ramp panel 12 of system 10, if compared to an exterior ramp of a similar length in a pre-existing system, may have a smaller ramp angle because the exterior ramp panel 12 has to travel a shorter vertical distance (e.g., from the ground to an outer edge of a tilted and/or lowered interior ramp panel 14).

FIG. 5 illustrates one method of adjusting the distance between the ground and the interior ramp panel 14, which may ease passenger access to a vehicle by providing a lower step. Although shown with the exterior ramp panel 12 retracted, the exterior ramp panel 12 may alternatively be extended. As shown in FIG. 5, the interior ramp panel 14 may move up (shown in solid lines) and down (shown in dotted lines) in conjunction with the first floor panel 16, thus raising or lowering the distance that a passenger may step from the ground to the interior ramp panel 14. However, in other embodiments, the interior ramp panel 14 may move up and down independently of the first floor panel 16 (e.g., as described in connection with FIGS. 2 and 3). When the exterior ramp panel 12 is extended, downward movement of the interior ramp panel 14 may lower the ramp angle between the exterior ramp panel 12 and the ground.

The movements of each of the movable panels (e.g., exterior ramp panel 12, interior ramp panel 14, first floor panel 16, and second floor panel 18) of system 10 may be controlled by one or more actuators that can raise, lower, and/or tilt a corresponding panel. The actuators may operate using electric current, hydraulic pressure, pneumatic pressure, or any other source of energy or combination of sources. The actuators may be located underneath the panels or in any other suitable location. Movement of the panels may be controlled via tracks and edges that provide for non-gap connections between adjacent panels. Additionally or alternatively, one or more of the panels may be manually movable by an operator.

Each panel described herein may include a composite material, although any other suitable material may be used. Each panel may be generally square or rectangular in shape, although the panels may be irregularly shaped and/or customized to a particular vehicle. The top surface of any of the panels may include a replaceable flooring insert to ease maintenance.

Adjacent panels may be connected by a mechanism that allows the required movements while preventing gaps and/or pressure between the panels. For example, the first floor panel 16 and the second floor panel 18 may include interlacing grooves and protrusions that maintain a connection between the two panels when the first floor panel 16 raises and lowers. The protrusions from the second floor panel 18 may in effect allow the second floor panel 18 to “expand” when the first floor panel 16 is lowered, but could then be pushed into grooves in the first floor panel 16 when the first floor panel 16 is raised.

In one example, the exterior ramp panel 12 may be wider than a door opening of the vehicle. The exterior ramp panel 12 in this example may be mounted underneath the vehicle chassis (e.g., on tracks), which may allow the panel to be wider than the space between the vehicle doors since the panel 12 would not have to fit through the door opening to be deployed. This example may improve the accessibility of the vehicle to users having wider wheelchairs or scooters.

The various panels described herein may be moved together or separately in any combination of motions described herein. In one exemplary method to deploy the exterior ramp panel 12, the system 10 may begin in the configuration of FIG. 2, with the second floor panel 18 and the first floor panel 16 at the same level as the fixed flooring 20. The interior ramp panel 14 may be at a lower level than the first floor panel 16, as shown in FIG. 2. Alternatively, the interior ramp panel 14 may be at the same level as the first floor panel 16. To deploy the exterior ramp panel 12, the interior ramp panel 14 may be lowered and/or tilted relative to the horizontal position shown in FIG. 2. For example, an outer edge of the interior ramp panel 14 may shift downward, while an inner edge adjacent to the first floor panel 16 may shift upward. The exterior ramp panel 12, either before, during, or after the tilting of the interior ramp panel 14, may slide outwardly towards the position shown in FIG. 1 until an edge contacts the ground surface. Alternatively, the exterior ramp panel 12 may flip up and outwards around axis 13 to deploy. After deployment, the exterior and interior ramp panels 12, 14 may be aligned to form a ramp from the ground surface into the vehicle.

The first floor panel 16, either before, during, or after the tilting of the interior ramp panel 14 and the deployment of the exterior ramp panel 12, may lower from the raised position shown in FIG. 2 to the lowered position shown in FIG. 1. This lowered position may allow for a smaller ramp angle to be achieved between the exterior ramp panel 12 and the ground. Once the user has ascended the ramp formed by the exterior and interior ramp panels 12, 14, the user may rest on the first floor panel 16. The first floor panel 16 may then be raised to the level of the fixed flooring 20, allowing the user to travel across a level surface from the first floor panel 16, over the second floor panel 18, and onto the fixed flooring 20. In an alternative embodiment, the user may ascend the ramp formed by the second floor panel 18 in the tilted position of FIG. 1 to move from the first floor panel 16 to the fixed flooring 20. The opposite motions may be carried out to retract the exterior ramp panel 12.

Another exemplary method to deploy the exterior ramp panel 12 may also begin in the configuration of FIG. 2, with the interior ramp panel 14 either in its shown position or raised to the level of the first floor panel 16. However, in this example, the interior ramp panel 14 may remain in its horizontal position while the exterior ramp panel 12 is deployed, according to the embodiments described herein, until an edge of the exterior ramp panel 12 contacts the ground. A user may then ascend the exterior ramp panel 12 until the user is resting on the horizontal interior ramp panel 14. The interior ramp panel 14 may then be raised to the level of the first floor panel 16. The user may then travel across a level surface from the interior ramp panel 14 to the first floor panel 16, then across the second floor panel 18 to the fixed flooring 20. Alternatively, the first floor panel 16 may be lowered to the level of the interior ramp panel 14 so that the two panels form a level surface. The user may then travel from the interior ramp panel 14 to the first floor panel 16. The first floor panel 16 may then be raised to the level of the fixed flooring 20, or alternatively, the user may ascend the ramp formed by the second floor panel 18 to reach the fixed flooring 20. The opposite motions may be carried out to retract the exterior ramp panel 12.

In yet another method of use, the panels may be moved to provide access to the bus from a platform that is raised above the level of the fixed flooring 20. In one example, the interior ramp panel 14 and/or the first floor panel 16 may be raised in horizontal positions to the level of the platform. A user may travel from the platform to the raised interior ramp panel 14, and after travelling across the interior ramp panel 14 to the first floor panel 16, the user may descend to the level of the fixed flooring 20 using a ramp formed by the second floor panel 18. Alternatively, the first floor panel 16 may be lowered, with the user, to the level of the fixed flooring 20. The exterior ramp panel 12 additionally or alternatively may be used in combination with the interior ramp panel 14 to provide access from a higher level. In one example, the exterior ramp panel 12 may at least partially rest on a platform, while the interior ramp panel 14 may be tilted to form a descending ramp from the exterior ramp panel 12 to the first floor panel 16. If the first floor panel 16 is in a position higher than the level the fixed flooring 12, the user may descend the ramp formed by the second floor panel 18. Alternatively, the first floor panel 16 may be level with, or lowered to the level of, the fixed flooring 20.

The various panels of the system 10 may allow for numerous different configurations to best suit the needs of the passenger trying to board a vehicle. The ability to adjust the ramp angle may accommodate users with different types of chairs or other physical characteristics that make entering a vehicle challenging. Similarly, the system 10 may allow the distance between the ground and the interior of the bus to be adjusted, which may eliminate the need to lower (“kneel”) and lift the entire weight of the vehicle to ease passenger access. Adjusting the panels of the ramp system 10 may be more efficient that adjusting the entire height of the vehicle. The system 10 may be used on buses, trucks, or any other type of vehicle that may benefit from easier access. In additional or alternative embodiments, the system 10 may be used to access stationary doorways that are raised above the ground, or to access a floor level that is higher than an adjacent floor level.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

1. An accessibility system for a vehicle, comprising:
an interior ramp panel movable between a first position and a second position, wherein, during use, the interior ramp panel is configured to remain inside the vehicle;
a first floor panel movable between a lowered position and a raised position; and
a second floor panel movable between a horizontal position and a tilted position.

2. The system of claim 1, further comprising an exterior ramp panel movable between a first position and a second position, wherein, during use, the exterior ramp panel is configured to contact a ground surface.

3. The system of claim 2, wherein in the first position, the exterior ramp panel is at least partially underneath the vehicle, and in the second position, the exterior ramp panel is at least partially protruding from a side of the vehicle.

4. The system of claim 2, wherein the exterior and interior ramp panels are configured to align to form a ramp from a ground surface into the vehicle.

5. The system of claim 1, wherein the interior ramp panel is movable to a same level as a level of a fixed floor portion of the vehicle.

6. The system of claim 1, wherein, in the raised position, the first floor panel is parallel to and at a same level as a level of a fixed floor portion of the vehicle.

7. The system of claim 1, wherein, in the horizontal position, the second floor panel is parallel to a fixed floor portion of the vehicle, and in the tilted position, the second floor panel extends from a level of the fixed floor portion to a level of the first floor panel.

8. An accessibility system for a vehicle, comprising:
an exterior ramp panel protruding from the vehicle and contacting a ground surface;
an interior ramp panel located inside of the vehicle and extending from the exterior ramp panel to contact a first edge of a first floor panel of the vehicle, wherein the exterior and interior ramp panels are aligned to form a first ramp from the ground surface into the vehicle; and
a second floor panel contacting a second edge of the first floor panel, the second edge being adjacent to the first edge, wherein the second floor panel forms a second ramp from the first floor panel to a fixed floor portion of the vehicle.

9. The system of claim 8, wherein the exterior ramp panel is slidable relative to and coupled to the interior ramp panel.

10. The system of claim 8, wherein, during use, the first floor panel and the second floor panel are configured to remain inside the vehicle.

11. The system of claim 8, wherein the interior ramp panel is movable from the position aligned with the exterior ramp panel to form the ramp from the ground surface into the vehicle to a horizontal position parallel to the fixed floor portion of the vehicle.

12. The system of claim 8, wherein the first floor panel is movable between a lowered position and a raised position.

13. The system of claim 12, wherein, in the raised position, the first floor panel is parallel to and at a same level as a level of the fixed floor portion of the vehicle.

14. The system of claim 8, wherein the second floor panel is movable between the position forming the ramp from the first floor panel to the fixed floor portion of the vehicle to a position parallel to the fixed floor portion of the vehicle.

15. A method for using an accessibility system for a vehicle, comprising:
sliding an exterior ramp panel relative to an interior ramp panel;
tilting the interior ramp panel from a horizontal position to a tilted position; and
at least one of raising or lowering a first floor panel,
wherein, in a deployed configuration of the accessibility system, the interior ramp panel remains inside of the vehicle.

16. The method of claim 15, further comprising moving a second floor panel.

17. The method of claim 15, wherein the exterior ramp panel is coupled to the interior ramp panel and, in the deployed configuration, the exterior ramp is positioned exterior to the interior ramp relative to the vehicle.

18. The method of claim 15, wherein the at least one of raising or lowering the first floor panel includes lowering the first floor panel to a level below a level of a fixed floor portion of the vehicle.

19. The method of claim 15, wherein the sliding occurs until an edge of the exterior ramp panel contacts a ground surface outside of the vehicle.

20. The method of claim 15, wherein, after the sliding and tilting, the exterior and interior ramp panels are aligned to form a ramp from a ground surface into the vehicle.
